(19) United States
(12) Patent Application Publication
(10) Pub. No.: US 2016/0010865 A1
(43) Pub. Date: Jan. 14, 2016

(54) FUEL LANCES HAVING THERMALLY INSULATING COATING

(71) Applicant: SIEMENS AKTIENGESELLSCHAFT, München (DE)

(72) Inventors: Michael Clossen-von Lanken Schulz, Issum (DE); Kai Kadau, Lake Wylie, SC (US); Jens Kleinfeld, Mülheim an der Ruhr (DE); Georg Rollmann, Mülheim Ruhr (DE); Kai-Uwe Schildmacher, Mülheim a.d. Ruhr (DE); Kagan Özkan, Neuss (DE)

(73) Assignee: SIEMENS AKTIENGESELLSCHAFT, Munich (DE)

(21) Appl. No.: 14/765,370

(22) PCT Filed: Jan. 17, 2014
(86) PCT No.: PCT/EP2014/050896

§ 371 Date: Aug. 3, 2015

(30) Foreign Application Priority Data
Feb. 5, 2013 (DE) 10 2013 201 843.6

(51) Int. Cl. F23R 3/28; B23P 15/00

(52) U.S. Cl. CPC F23R 3/283; B23P 15/00

(57) ABSTRACT

A method for producing a fuel lance for a burner, in particular for a gas turbine burner, has at least the following steps: creating a fuel lance body having a tip that has a cooling air duct, which opens into an exit opening extending around a longitudinal axis of the fuel lance body, and a nozzle face, which is arranged around the exit opening and has a plurality of fuel nozzles; determining a spatial distribution of a heat input, to which the nozzle face is subjected during operation when a fuel flowing out through the fuel nozzles is burnt; and applying a thermally insulating layer onto the nozzle face in accordance with the spatial distribution of the heat input. A fuel lance is produced with the method. A burner has such a fuel lance.

### CROSS REFERENCE TO RELATED APPLICATIONS

This application is the US National Stage of International Application No. PCT/EP2014/050896 filed Jan. 17, 2014, and claims the benefit thereof. The International Application claims the benefit of German Application No. DE 102013201843.6 filed Feb. 5, 2013. All of the applications are incorporated by reference herein in their entirety.

### FIELD OF INVENTION

The present invention relates to a method for producing an improved fuel lance, to an improved fuel lance, and to a burner having a fuel lance of said type.

### BACKGROUND OF INVENTION

Fuel lances are used in burners which can be operated both with liquid fuel and with gaseous fuel. In general, the fuel lance is provided for operation with liquid fuels, for example oil. The liquid fuel flows through the fuel lance and, at the tip thereof, emerges through fuel nozzles into a combustion chamber, with the fuel being atomized. The fuel lances furthermore comprise a cooling air duct through which air which is compressed by a compressor passes into the combustion chamber, which air mixes with the liquid fuel atomized by the fuel nozzles. The compressed air burns with the liquid fuel to form a hot exhaust gas. The flow pressure generated by the hot exhaust gas normally drives a gas turbine which, in addition to the compressor for the cooling air and/or the combustion air, can drive for example an electrical generator.

During operation, the tip of the fuel lance is, owing to the proximity of the flame, exposed to high temperatures in a range up to approximately 1000 degrees Celsius. By contrast, the liquid fuel and the cooling air are at considerably lower temperatures and cool the fuel lance in the region around the respective outlet openings. In this way, it is often the case that, at the tip of the fuel lance, steep temperature gradients arise which lead to mechanical stresses and ultimately to cracks.

It is proposed in WO 2010/066516 A2 that the tip of the fuel lance be equipped with slots which permit thermal expansion of the heated material and which are thus intended to reduce the mechanical stresses in the tip of the fuel lance. Such slots however cannot be provided at all surface locations of the tip of the fuel lance without impairing the stability thereof.

### SUMMARY OF THE INVENTION

It is therefore an object of the invention to introduce a method for producing an improved fuel lance, an improved fuel lance, and a burner having a fuel lance of said type.

A first aspect of the invention therefore introduces a method for producing a fuel lance for a burner, in particular for a gas turbine burner. The method has at least the following steps:—creating a fuel lance body with a tip which has a cooling air duct, which cooling air duct issues into an outlet opening extending around a longitudinal axis of the fuel lance body, and a nozzle surface, which nozzle surface is arranged around the outlet opening and has a multiplicity of fuel nozzles;—determining a spatial distribution of a heat input experienced by the nozzle surface in operation during the combustion of a fuel that is caused to flow out through the fuel nozzles; and—applying a thermal insulation layer to the nozzle surface in a manner dependent on the spatial distribution of the heat input.

In this case, the step of determining the spatial distribution of the heat input only needs to be carried out once for a particular type of fuel lance body, whereas the further steps may be repeated as often as desired in order to produce a greater number of fuel lances according to the invention. For this purpose, the spatial distribution of the heat input may be stored for future use. The heat input may in this case be determined for example by measurement in (testing) operation or on the basis of computer simulations or calculations.

The method of the invention provides a means of producing improved fuel lances. By virtue of a thermal insulation layer being applied to the nozzle surface in a manner dependent on the spatial distribution of the heat input generated during the operation of the fuel lance, the temperature gradients in the tip of the fuel lance can be greatly reduced, which prevents the generation of intense mechanical stresses within the tip of the fuel lance. In this way, the occurrence of cracks can be prevented, which lengthens the service life of the fuel lance.

The step of determining the spatial distribution of the heat input may comprise a first step of determining a first heat input and a second step of determining a second heat input. In this case, the first heat input is the heat input experienced by a first surface location of the nozzle surface in operation during the combustion of the fuel that is caused to flow out through the fuel nozzles. The second heat input is accordingly the heat input experienced by a second surface location of the nozzle surface in operation during the combustion of the fuel that is caused to flow out through the fuel nozzles. In this case, the thermal insulation layer is applied to the first surface location with a first layer thickness and to the second surface location with a second layer thickness.

This means for example that, if the first surface location experiences greater heat input than the second surface location, the thermal insulation layer applied to the first surface location should have a greater layer thickness than the thermal insulation layer applied to the second surface location, and vice versa. This offers the advantage that the temperature distribution in the tip of the fuel lance is homogenized in a particularly effective manner, whereby the temperature gradients are reduced to a particularly great extent. The invention however also encompasses embodiments in which the thermal insulation layer is applied with a substantially constant layer thickness.

It may also be considered advantageous if the abovementioned method step—specifically the application of the thermal insulation layer to the first surface location with a first layer thickness and to the second surface location with a second layer thickness—is enhanced such that a selected layer thickness out of first and second layer thickness is selected to be greater than a remaining layer thickness out of first and second layer thickness if a heat input, associated with the selected layer thickness, out of first heat input and second heat input is greater than a heat input, associated with the remaining layer thickness, out of first heat input and second heat input.

This means for example that, if the first surface location experiences greater heat input than the second surface location, the thermal insulation layer applied to the first surface location should have a greater layer thickness than the thermal insulation layer applied to the second surface location, and vice versa. This offers the advantage that the temperature distribution in the tip of the fuel lance is homogenized in a particularly effective manner, whereby the temperature gradients are reduced to a particularly great extent. The invention however also encompasses embodiments in which the thermal insulation layer is applied with a substantially constant layer thickness.

In a variant of the method, the thermal insulation layer may be applied to the first and second surface locations by virtue of, in a first step, a first partial layer of the thermal insulation layer being applied to both the first and the second surface location and, in a second step, a second partial layer of the thermal insulation layer being applied to either the first or the second surface location.

The application of the thermal insulation layer with variable layer thickness as a series of partial layers laid one top of the other permits precise spatial control of the layer thicknesses of the thermal insulation layer. Here, it is to be considered equivalent for a partial layer of relatively small spatial extent to be applied on or below (or temporally before or after) a partial layer of relatively large spatial extent.

The thermal insulation layer is particularly applied only to those regions of the nozzle surface in which the heat input lies above a predetermined first threshold.

In this way, the application of the thermal insulation layer is simplified and material is saved. Furthermore, even the thermal insulation layer will not fully prevent a heat input into the tip of the fuel lance, for which reason an omission of the thermal insulation layer at locations at which the heat input lies below the first threshold value will have the result that the heating of the parts without thermal insulation layer approximately corresponds to the heating of the parts in the regions with thermal insulation layer, whereby in turn, temperature gradients are eliminated or lessened.

In an embodiment, a first partial layer is applied to those regions of the nozzle surface in which the heat input lies above a predetermined first threshold. Furthermore, a second partial layer is additionally applied to those regions of the nozzle surface in which the heat input lies above a predetermined second threshold which is higher than the first threshold.

As a result, the nozzle surface has at least three regions: a first without thermal insulation layer, a second with only the first partial layer, and a third with the first and the second partial layers, whereby the layer thickness of the resulting thermal insulation layer in the third region is greater than that in the second region. The heat input in the third region is in this case greater than that in the second region, which in turn is greater than the heat input in the first region, such that the occurring temperature gradients are substantially leveled.

A spatial layer thickness of the thermal insulation layer is particularly selected as a function of the spatial distribution of the heat input.

That is to say, the thermal insulation layer is formed with a respective layer thickness which is dependent on the heat input to be expected for that location.

In particular, the spatial layer thickness of the thermal insulation layer may be selected proportionally to the spatial distribution of the heat input.

A second aspect of the invention introduces a fuel lance for a burner, in particular for a gas turbine burner, which fuel lance is or can be produced by way of the method according to the invention.

Said fuel lance has a fuel lance body with a tip which has a cooling air duct, which cooling air duct issues into an outlet opening extending around a longitudinal axis of the fuel lance body, and a nozzle surface, which nozzle surface is arranged around the outlet opening and has a multiplicity of fuel nozzles. According to the invention, the fuel lance furthermore has a thermal insulation layer which is applied to the nozzle surface in a manner dependent on a spatial distribution of the heat input experienced by the nozzle surface in operation during the combustion of a fuel which is caused to flow out through the fuel nozzles.

It may advantageously be provided that the thermal insulation layer is arranged at least regionally in annular fashion around the outlet opening of the cooling air duct.

It is at this location that the compressed air and the liquid fuel impinge on one another for the first time, for which reason it is the case here that the flame has a small spacing to the tip of the fuel lance and thus also imparts a particularly high heat input. Furthermore, between the outlet opening and the oil nozzles, the fuel lance has a relatively narrow structure which would be subject to particularly intense and steep temperature gradients and mechanical stresses.

It may furthermore advantageously be provided that the thermal insulation layer has a multiplicity of projections, each of which extends on the nozzle surface between two adjacent fuel nozzles.

The inventors have recognized that the local cooling of the fuel nozzles by the outflowing liquid fuel also results in particularly large temperature gradients between the fuel nozzles and the regions of the nozzle surface between the individual fuel nozzles; it is the intention for said temperature gradients to be reduced by way of the projections of the thermal insulation layer.

A further aspect of the invention introduces a burner, in particular a gas turbine burner. According to the invention, the burner comprises at least one fuel lance which is designed in accordance with the claims.

### BRIEF DESCRIPTION OF THE FIGURES

The invention will be discussed in more detail below on the basis of figures, in which:

FIG. 1 shows a perspective view of a tip of a conventional fuel lance with a spatial distribution of a heat input during the operation of the fuel lance;

FIG. 2 shows a frontal plan view of the tip of FIG. 1;

FIG. 3 shows a first embodiment of the fuel lance according to the invention; and

FIG. 4 shows a second embodiment of the fuel lance according to the invention.

### DETAILED DESCRIPTION OF THE FIGURES

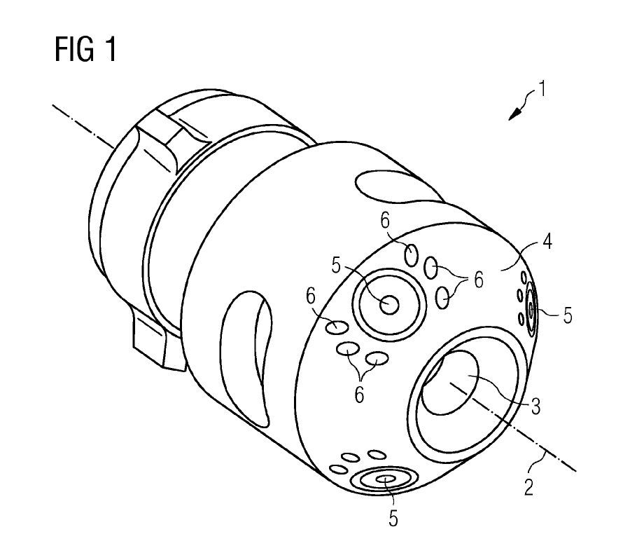

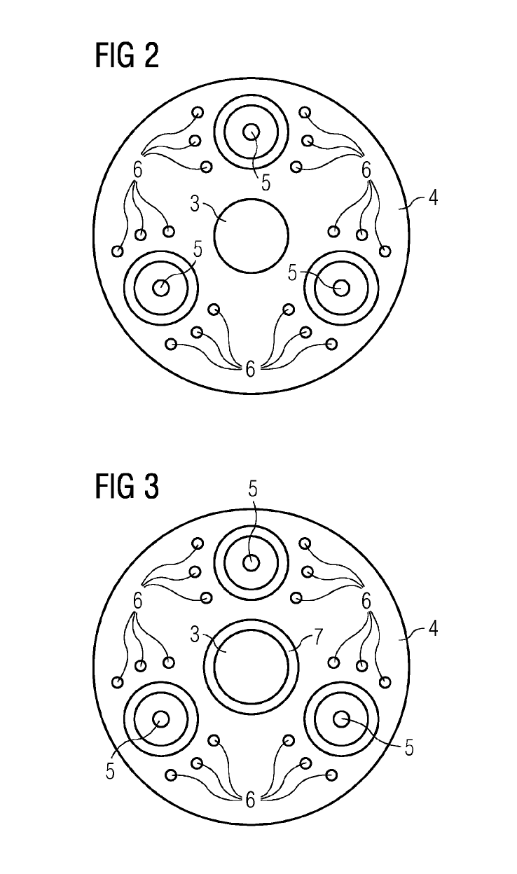

FIG. 1 shows a perspective view of a tip 1 of a conventional fuel lance with a spatial distribution of a heat input during the operation of the fuel lance. FIG. 2 shows a frontal plan view of the tip 1 from FIG. 1. Here, the same reference signs are used to denote the same elements, which will be discussed in more detail below.

The tip 1 of the fuel lance is normally of rotationally symmetrical form about a longitudinal axis 2 of the fuel lance. Running in the interior of the tip 1 of the fuel lance there is a cooling air duct which opens, at an outlet opening 3, into a combustion chamber of a burner. On a nozzle surface 4, which is for example of at least approximately frustoconical form, multiple fuel nozzles 5 are arranged along the circumference of the nozzle surface 4, which fuel nozzles each centrally have a nozzle opening for the atomization and outflow of the liquid fuel. Here, any desired number of fuel nozzles 5 may be provided, although a number of three fuel nozzles has proven to be an advantageous compromise between the complexity of the design and the spatial distribution of the liquid fuel in the combustion chamber. Around the fuel nozzles 5, there may optionally be provided additional cooling air bores 6 through which likewise compressed air can flow out from the cooling air duct.

The analysis of the spatial distribution of the heat input shows that the highest temperatures prevail in the regions around the outlet opening 3 and between the fuel nozzles 5 and the cooling air bores 6 of adjacent fuel nozzles 5. The liquid fuel flowing out of the fuel nozzles 5 and the air emerging from the outlet opening 3 and possibly from the cooling air bores 6 cool the regions surrounding said openings, such that, between said hot regions, on the one hand, and said cooled regions, on the other hand, steep temperature gradients are generated which, in particular in the region directly between the fuel nozzles 5 and the outlet opening 3, can lead to cracks which shorten the service life of the fuel lance.

FIG. 3 shows a first embodiment of the fuel lance according to the invention. The fuel lance according to the invention is of substantially the same construction as the conventional fuel lances of FIGS. 1 and 2. Said fuel lance however additionally has a thermal insulation layer 7 or 8 arranged on the nozzle surface 4, said thermal insulation layer being arranged annularly around the outlet opening 3 in the exemplary embodiment of FIG. 3. This arrangement, while yielding a minimal surface area of the thermal insulation layer 7, protects the most sensitive region of the tip of the fuel lance 1, which is situated between the outlet opening 3 and the fuel nozzles 5.

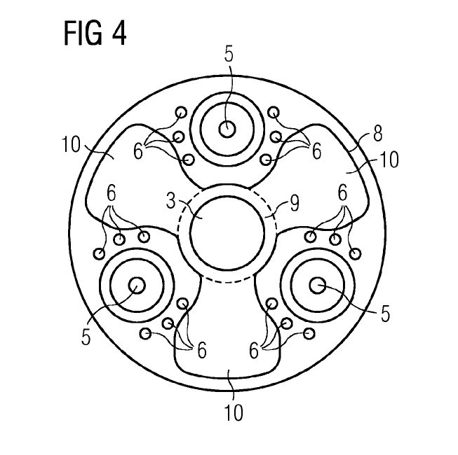

FIG. 4 shows a second embodiment of the fuel lance according to the invention, in which the thermal insulation layer 8 is applied both to the region 9 between the outlet opening 3 and the fuel nozzles 5 as in the case of the first exemplary embodiment, and in the form of projections 10, which are particularly provided in a number corresponding to the number of fuel nozzles 5 and which are each arranged between two adjacent fuel nozzles 5, to the regions between the fuel nozzles 5. In the drawing, the annular region 9, which corresponds to that of the thermal insulation layer 7 in the example of FIG. 3, is separated from the projections 10 by way of a dashed line in order to provide a clearer illustration. In reality, the thermal insulation layer 8 is however advantageously of unipartite and continuous form.

In all of the embodiments of the invention that are shown, a layer thickness of the thermal insulation layers 7 and 8 may spatially vary, as has already been discussed in detail.

The invention offers the advantage of a lengthened service life of the fuel lances produced according to the invention, by virtue of the fact that a selectively applied thermal insulation layer reduces the temperature gradients generated in operation in the tip of the fuel lances and thus protects the tip of the fuel lances against intense mechanical stresses which would lead to cracks and thus to damage or destruction of the fuel lance.

Even though the invention has been described in more detail on the basis of exemplary embodiments, the exemplary embodiments should not be regarded as restricting the invention. Rather, deviations from the exemplary embodiments shown are possible without departing from the scope of protection of the following claims.

1-13. (canceled)

14. A method for producing a fuel lance for a gas turbine burner, comprising:
creating a fuel lance body with a tip which has a cooling air duct, which cooling air duct issues into an outlet opening extending around a longitudinal axis of the fuel lance body, and a nozzle surface, which nozzle surface is arranged around the outlet opening and has a multiplicity of fuel nozzles;
determining a spatial distribution of a heat input experienced by the nozzle surface in operation during the combustion of a fuel that is caused to flow out through the fuel nozzles; and
applying a thermal insulation layer to the nozzle surface in a manner dependent on the spatial distribution of the heat input, and
wherein the thermal insulation layer is arranged at least regionally in annular fashion around the outlet opening of the cooling air duct,
wherein the step of determining the spatial distribution of the heat input comprises:
first determining a first heat input experienced by a first surface location of the nozzle surface in operation during the combustion of the fuel that is caused to flow out through the fuel nozzles, and
second determining a second heat input experienced by a second surface location of the nozzle surface in operation during the combustion of the fuel that is caused to flow out through the fuel nozzles, and
wherein the thermal insulation layer is applied to the first surface location with a first layer thickness and to the second surface location with a second layer thickness.

15. The method as claimed in claim 14,
wherein the thermal insulation layer is applied to the first surface location with a first layer thickness and to the second surface location with a second layer thickness,
wherein a selected layer thickness out of first and second layer thickness is selected to be greater than a remaining layer thickness out of first and second layer thickness if a heat input, associated with the selected layer thickness, out of first heat input and second heat input is greater than a heat input, associated with the remaining layer thickness, out of first heat input and second heat input.

16. The method as claimed in claim 14,
wherein the thermal insulation layer is applied to the first and second surface locations by,
in a first step, a first partial layer of the thermal insulation layer being applied to both the first and the second surface location and,
in a second step, a second partial layer of the thermal insulation layer being applied to either the first or the second surface location.

17. The method as claimed in claim 14,
wherein the thermal insulation layer is applied only to those regions of the nozzle surface in which the heat input lies above a predetermined first threshold.

18. The method as claimed in claim 14,
wherein a first partial layer is applied to those regions of the nozzle surface in which the heat input lies above a predetermined first threshold, and
wherein a second partial layer is additionally applied to those regions of the nozzle surface in which the heat input lies above a predetermined second threshold which is higher than the first threshold.

19. The method as claimed in claim 14,
wherein a spatial layer thickness of the thermal insulation layer is selected as a function of the spatial distribution of the heat input.

20. The method as claimed in claim 19,
wherein the spatial layer thickness of the thermal insulation layer is selected proportionally to the spatial distribution of the heat input.

21. A fuel lance for a gas turbine burner, the fuel lance produced by the method as claimed in claim 14.

22. A fuel lance for a gas turbine burner, wherein the fuel lance comprises:
a fuel lance body with a tip which has a cooling air duct, which cooling air duct issues into an outlet opening extending around a longitudinal axis of the fuel lance body, and a nozzle surface, which nozzle surface is arranged around the outlet opening and has a multiplicity of fuel nozzles, and
a thermal insulation layer applied based on a spatial distribution of the heat input experienced by the nozzle surface in operation during the combustion of a fuel which is caused to flow out through the fuel nozzles,
wherein the thermal insulation layer is arranged at least regionally in annular fashion around the outlet opening of the cooling air duct.

23. The fuel lance of claim 22,
wherein the thermal insulation layer has a multiplicity of projections, each of which extends on the nozzle surface between two adjacent fuel nozzles.

24. A gas turbine burner, comprising:
at least one fuel lance as claimed in claim 22.
